(19) United States
(12) Patent Application Publication
(10) Pub. No.: US 2023/0289879 A1
(43) Pub. Date: Sep. 14, 2023

(54) SYSTEMS AND METHODS FOR OBTAINING AND ANALYZING SHAREHOLDER INFORMATION

(71) Applicant: OWND LLC., Miami, FL (US)

(72) Inventors: Monte Traficante, Miami, FL (US); Adam Bonner, Miami, FL (US); Andrew Mclendon, Miami, FL (US); Vic Liu, Miami, FL (US)

(21) Appl. No.: 18/119,767

(22) Filed: Mar. 9, 2023

Related U.S. Application Data
(60) Provisional application No. 63/318,184, filed on Mar. 9, 2022.

(51) Int. Cl. G06Q 40/04

(52) U.S. Cl. CPC G06Q 40/04

(57) ABSTRACT

A method comprising collecting a user ownership data set including a number of shares of stock that a user owns in a first company; collecting an offer data set including a first offer for shareholders who own a first threshold number of shares in the first company; and publishing the first offer to the user that owns the number of shares of stock of the first company, systems that implement such methods, and non-transitory computer readable media having instructions that when executed by a processor cause a computing device to implement such methods.

### CROSS REFERENCE TO RELATED APPLICATIONS

This application claims priority to U.S. Provisional Application No. 63/318,184 filed on Mar. 9, 2022, the contents of which are herein incorporated by reference in their entirety.

### FIELD OF THE DISCLOSURE

This disclosure relates generally to methods and systems for obtaining and analyzing data, and more specifically data related to individual owners and stakeholders in publicly traded securities.

### BACKGROUND

Publicly traded companies are typically listed on stock exchanges, such as the Nasdaq® stock exchange or the New York Stock Exchange®. Securities, including company stock, listed on these exchanges are typically bought or sold through brokers such as banks or online platforms. There may be thousands, or even millions, of individuals who own shares in a publicly traded company, and yet the company will have limited to no information about these individuals due to the company's stock being traded through a broker. Additionally, most publicly traded shares are not actually owned by individual investors but rather by groups of investors operating as a single entity, such as an investment fund or firm. This further shields the identity and demographic characteristics of the individual stakeholders from the company. If a publicly traded company had access to the demographic information of the individuals holding ownership interests in the company, the company could make more informed business decisions.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one embodiment, a method may include collecting a user ownership data set including a number of shares of stock that a user owns in a first company, collecting an offer data set including a first offer for stakeholders who own a first threshold number of shares in the first company, and publishing the first offer to the user that owns the number of shares of stock of the first company. In a further embodiment, a non-transitory computer readable medium may contain instructions that when executed by a processor causes a computing system to collect a user ownership data set including a number of shares of stock that a user owns in a first company, collect an offer data set including a first offer for stakeholders who own a first threshold number of shares in the first company, and publishing the first offer to the user that owns the number of shares of stock of the first company. In another embodiment, a system may include a computing device comprising a memory and a processor, the computing device may be capable of receiving information from a user to collect a user ownership data set including a number of shares of stock that the user owns in a first company, and the computing device capable of receiving offer information from an offeror to collect an offer data set including a first offer for shareholders who own a first threshold number of shares in the first company, and the computing device further capable of communicating with a user computing devise operated by the user to publish the first offer to the user that owns the number of shares of stock of the first company.

### BRIEF DESCRIPTION OF THE FIGURES

The drawings set forth exemplary embodiments of the disclosed concepts, and are not intended to be limiting in any way.

FIG. 1 illustrates a method for presenting offers to the shareholders of a company.

FIG. 2 illustrates a method for collecting a user ownership data set.

FIG. 3 illustrates a method for collecting an offer data set.

FIG. 4 illustrates a method of publishing an offer to a user.

FIG. 5 illustrates a method for conveying the benefit of an offer to a user.

FIG. 6 illustrates a system diagram for a system for presenting offers to the shareholders of a company.

FIG. 7 illustrates a user interface for a user device application that can communicate with a system for presenting offers to the shareholders of a company.

### DETAILED DESCRIPTION OF THE DISCLOSURE

The following detailed description and the appended drawings describe and illustrate some embodiments for the purpose of enabling one of ordinary skill in the relevant art to make use the invention. As such, the detailed description and illustration of these embodiments are purely illustrative in nature and are in no way intended to limit the scope of the invention, or its protection, in any manner. It should also be understood that the drawings are not necessarily to scale and in certain instances details may have been omitted, which are not necessary for an understanding of the disclosure, such as details of fabrication and assembly. In the accompanying drawings, like numerals represent like components.

In one embodiment, a system may comprise at least a memory unit and a processor, and the system may obtain demographic data from an individual interested in acquiring a security interest, such as shares of a publicly traded company. This demographic data may be voluntarily provided by the user, or the data be mined by the central network publicly available demographic data sources using known or to be developed data mining methods. Demographic data may include user information such as age, gender, location, and other socio-economic information about the user as may be legally permissible to obtain. Incentives may be provided to the user, such as a discounts to purchase stock or other securities, to provide demographic data. The central network may also acquire transaction data from online brokers. Transaction data may include information regarding the purchase or sale of securities, including positions that a user have on certain securities. The transaction data and demographic data may be analyzed and associated with one another by the central server resulting in investor data, and the investor data may be made available to third parties including companies whose stocks are connected with the transaction data. Through the investor data, third parties will be able to summarize the demographics of owners and stakeholders in the company's publicly traded stocks. Additionally, investor data may be sorted or filtered to shield personally identifiable information that could be collected as part of the demographic data.

In some embodiments, a security exchange module may be incorporated into the system. A security exchange module may acquire shares of a company through a third-party platform, such as a stock broker, and make these shares available to users of the central network. A token may be generated associating the demographic and transaction data, and the token may be stored in system database. It should be understood that tokens could be generated, stored, and transferred using a blockchain ledger. In some embodiments, the token may be, or incorporate, a scannable or machine readable code such as a bar code or a QR code.

In a further embodiment, a marketing rewards module may be incorporated into the system. A user of the system could opt-in to a monthly subscription for investing with purchases. The system could initiate automatic trades based on purchases from retailers, and in turn the system could automatically invest fractional shares in public securities with each transaction. Consequentially, the system could receive payment for order flow (PFOF) from third parties in the industry. In one example, a user of the system could purchase $99 of merchandise from the company, and the system could be programmed to ‘round up’ the purchase to $100, with the extra $1 being used to purchase stock from the company providing the merchandise. The system could incorporate this marketing data into the investor data.

In another embodiment, a method may include collecting a user ownership data set including a number of shares of stock that a user owns in a first company, collecting an offer data set including a first offer for stakeholders who own a first threshold number of shares in the first company, and publishing the first offer to the user that owns the number of shares of stock of the first company.

In further embodiments, collecting the user ownership data set may include collecting demographic information about the user including the user's name, birthdate, social security number, mailing address, phone number, or email address. Collecting the user ownership data set may include a purchase date establishing when the number of shares of the stock of the first company were purchased by the user. Collecting user ownership data set may include transactional data showing the user's historical purchase and sale of shares of stock of the first company.

In a further embodiment, a non-transitory computer readable medium may contain instructions that when executed by a processor causes a computing system to collect a user ownership data set including a number of shares of stock that a user owns in a first company, collect an offer data set including a first offer for stakeholders who own a first threshold number of shares in the first company, and publishing the first offer to the user that owns the number of shares of stock of the first company. In another embodiment, a system may include a computing device comprising a memory and a processor, the computing device may be capable of receiving information from a user to collect a user ownership data set including a number of shares of stock that the user owns in a first company, and the computing device capable of receiving offer information from an offeror to collect an offer data set including a first offer for shareholders who own a first threshold number of shares in the first company, and the computing device further capable of communicating with a user computing devise operated by the user to publish the first offer to the user that owns the number of shares of stock of the first company. Collecting the user ownership data set may include aggregating the transactional data into a history of ownership of the stock of the first company by the user. Collecting user ownership data set may include linking to the user's account on a third-party brokerage in order to collect verified data for the ownership data set. Collecting user ownership data set may include a number of shares of stock that a user owns in a second company. Collecting user ownership data set may include a number of shares of stock that a user owns for each company in his portfolio. The method may include updating the user ownership data set. Updating the user ownership data set may be performed periodically. Collecting an offer data set may include a second offer for shareholders who own a second threshold number of shares in the first company. The first threshold number of shares and the second threshold number of shares may be the same. The first offer may be tiered having additional threshold number of shares and tiered benefits depending on which of the threshold number of shares is met. The first offer may be from the first company or an affiliate of the first company. The first offer may be from a company that is unaffiliated with the first company. The first offer may include qualifying terms. The qualifying terms may require ownership of the first threshold number of shares of the first company for a first time period. The qualifying terms may require ownership of the first threshold number of shares of the first company. The qualifying terms may require ownership of a second threshold of stock in the first company, wherein the first threshold is different from the first threshold. The qualifying terms may require ownership of a second threshold of stock in a second company. The first offer may require ownership of the threshold number of shares at the time the first offer is accepted or redeemed. The first offer may further include a discount on a good or service. The first offer may include access to a VIP membership. The first offer may include a coupon.

Further embodiments may include obtaining the user's authorization to share information from the user ownership data set with the first company. Embodiments may include obtaining the user's authorization to share information from the user ownership data set with affiliates of the first company. Embodiments may also include obtaining the user's authorization to share information from the user ownership data set with companies that are unaffiliated with the first company. The publishing the first offer to the user that owns the number of shares of stock of the first company may include verifying that the user qualifies for the first offer may indicate that the first offer is available to the user for acceptance or redemption. Publishing the first offer to the user that owns the number of shares of stock of the first company may include verifying that the user does not qualify for the first offer and indicating the requirements that the user must meet in order to qualify for the first offer. The publishing the first offer may include verifying which tiers a user qualifies for and which tiers a user does not qualify for and indicating which tiers of the first offer are available to be accepted or redeemed and which requirements the user must meet in order to qualify for tiers for which the user is not eligible. It may also include receiving a request from the user to accept or redeem the first offer. Embodiments may also verify that the user qualifies for the offer at the time of acceptance or redemption. Embodiments may convey to the user the benefit of the first offer. Embodiments may include conveying to an offeror of the first offer a subset of data from the user ownership data set, so that the offeror may verify that the user qualifies for the offer at the time of redemption. Embodiments may include conveying to an offeror of the first offer a subset of data from the user ownership data set, so that the offeror may convey the benefit of the first offer to the user. In some embodiments, receiving from the offeror of the first offer may include a percentage of a sale of goods or services made from the acceptance or redemption of the first offer. There may also be receiving from the offeror a payment of a fee for conveying the subset of data from the user ownership data set. An embodiment could include receiving from the a third party a fee for access to information the user ownership data set. An embodiment could further include forming an aggregated ownership data set by aggregating the user ownership data set with similar data sets for other users. Further embodiments may use the aggregated ownership data set to generate offers from offerors for the user. Additional embodiments may sell access to the aggregated ownership data set or a subset thereof to potential offerors.

In a further embodiment, a non-transitory computer readable medium may contain instructions that when executed by a processor causes a computing system to collect a user ownership data set including a number of shares of stock that a user owns in a first company, collect an offer data set including a first offer for stakeholders who own a first threshold number of shares in the first company, and publishing the first offer to the user that owns the number of shares of stock of the first company. In another embodiment, a system may include a computing device comprising a memory and a processor, the computing device may be capable of receiving information from a user to collect a user ownership data set including a number of shares of stock that the user owns in a first company, and the computing device capable of receiving offer information from an offeror to collect an offer data set including a first offer for shareholders who own a first threshold number of shares in the first company, and the computing device further capable of communicating with a user computing devise operated by the user to publish the first offer to the user that owns the number of shares of stock of the first company.

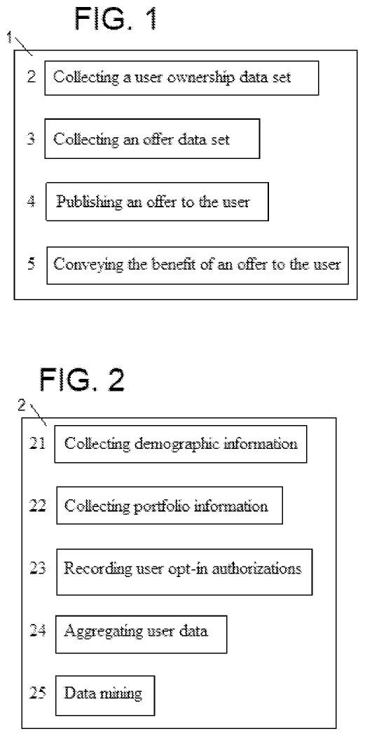

FIGS. 1-5 illustrate a method for presenting offers to the shareholders of a company 1 in according with the disclosed concepts. Such methods can be implemented in the context of a system which may be developed to implement one or more of the disclosed concepts. Any references to “the system” or “a system” should be understood to be references to systems that embody, illustrate, or describe the methods disclosed herein.

FIG. 1 illustrates a method for presenting offers to the shareholders of a company 1, which may include collecting a user ownership data set 2, collecting an offer data set 3, publishing an offer to the user 4, and conveying the benefit of an offer to the user 5. Collecting a user ownership data set 2 may generally include collecting information about one or more users and their stock holding that may later be used to present the users with offers from offerors which may be published to the user and which the user may qualify for depending upon the information collected within the user ownership data set. The data collected and used within the ownership data set may reside on a single database on a single computing device or in one or more databases that are spread out over one or more computing devices with or without redundancy or centralization. In some embodiments a centralized database may control and manage all such data and queries for same. However, any suitable database architecture known in the art or to be developed may be used with the disclosed concepts. Collecting an offer data set 3 may generally include collecting information about offers that offerors are willing to present to shareholders of a company. For purposes of this disclosure it can be assumed that users who use a brokerage account to purchase common stock shares of a publicly traded company are shareholders that own those shares irrespective of the technicalities on when such ownership is actually conferred. Collecting a user ownership data set 2 and collecting an offer data set 3 may be performed in any order, and in some embodiments may be iterative processes in which both data sets are updated, at either discrete or routine times, in order to keep the information contained therein current. Publishing an offer to the user 4 may generally include displaying offers which a user is eligible to see and/or accept or redeem based on their respective data in the user ownership data set. Conveying the benefit of an offer to the user 5 may generally include direct or indirect ways that a user may accept or redeem offers that they are eligible for based on their stock ownership.

FIG. 2 illustrates a method for collecting a user ownership data set 2. Collecting a user ownership data set 2 may include collecting user demographic information 21; collecting portfolio information 22; recording user opt-in authorizations 23; aggregating user data 24 for broader analysis and data mining 25.

Collecting user demographic information 21 may include collecting identifying information that can be affiliated with a know your customer (KYC) system, such as the user's name, birthdate, social security number, mailing address, phone number, or email address. It may also include additional information about the user such as whether they are an accredited investor, their income, their spending habits, other assets held by the user, credit scores, and any other information about the user that may be relevant to offers that offerors wish to make to the user. Collecting portfolio information 22 may include collecting information about what stocks a user owns, including a number of shares of stock that a user owns in a first company. In some embodiments this may further include a purchase date establishing when the number of shares of each currently owned stock was purchased by the user, and may further include a more robust portfolio history including all transactions entered into by the user purchasing or selling stocks, options, futures, bonds, or any other assets or instruments that may be of interest to potential offerors. In some embodiments collecting portfolio information 22 may include linking to the user's account on a third-party brokerage in order to collect verified data for the ownership data set. This can be accomplished securely and safely by using a brokerage's API with public and private cryptography keys, through the use of third-party services such as PLAID™ or the like, or through any other method known in the art or to be developed, in accordance with the disclosed concepts. Such verification step provides the offerors with security in knowing that the users have been vetted and the information that they are basing their offers on is true and correct, at least as of the time it was gathered. Recording user opt-in authorizations 23 may include presenting the user with a software license agreement and/or terms of use that they must agree to in order to use the system, in addition to mandatory and optional authorizations that the user may provide in order to use and/or gain benefit from certain aspects of the system, such as: agreeing to authorize disclosure of the users aggregated information only; agreeing to authorize disclosure of user-specific information to companies for which the user owns stock that have joined the system and have offers available; agreeing to authorize disclosure of the user-specific information to any company for which they own stock; agreeing to authorize disclosure of the user-specific information to any affiliate or partner of a company for which they own stock; agreeing to authorize disclosure of the user-specific information to any offeror willing to make an offer which the user may be eligible to see because of their portfolio; or agreeing to authorize disclosure of the user-specific information to any company. Numerous possibilities and permutations for such authorizations are contemplated within the scope of the disclosed concepts depending on a chosen implementation. In some embodiments some authorizations may be mandatory, while others may be optional. For example a system may be implemented such that it is mandatory to disclose information to offerors for which the user is an owner of the offeror's stock, but it is optional to for the user to authorize disclosures to affiliates or to third-party offerors. Aggregating user data 24 may include any method known in the art or to be developed to aggregate and/or anonymize user data which can then either be sold or licensed to third parties or used as the basis for presenting offers to certain classes of users based on their membership to certain categories—such as offers based on risk behavior (i.e. percentages of the portfolio a user uses for options vs bonds, or any other such metric). Data mining 25 refers generally to any methodology known in the art or to be developed that may be used internally or licensed or sold to offerors or to third parties to derive useful insight from the user data collected.

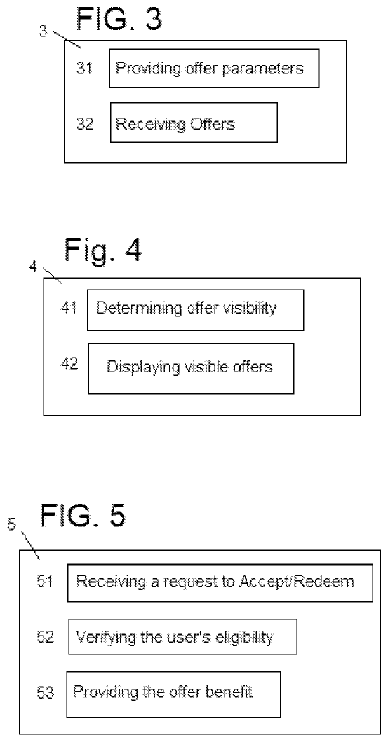

FIG. 3 illustrates a method for collecting an offer data set 3. Collecting an offer data set may include providing offerors with offer parameters 31; and receiving offers from offerors 32. Providing offer parameters 31 may include contacting participating offerors (or potential offerors) to disclose the parameters that they may use for making offers. This may include the ability to set a viewing threshold of stocks (or a particular class of stock) of a certain company that must be owned in order for a user to receive notice that an offer is available; an eligibility threshold that must be met in order to qualify for the offer, other qualifying terms, which may be the same as or different from the viewing threshold, conferred benefits parameters, such as the identification of the product or service that will be discounted as part of the offer, or what other benefits may be made available to the user. Other qualifying terms may include requirements for how long a stock must be owned for the user to qualify for the offer, whether the offeror needs to own the stock when the offer is made, when it is accepted, at both times or at all times in between. Any other suitable qualifying terms known in the art or to be developed may be used in accordance with the disclosed concepts. An offeror may make multiple offers to users for different products or services, or even for the same product with multiple tiers of benefits (i.e., a larger discount depending on the number of shares of the relevant company owned. Alternatively, an offeror may make a single tiered offer with multiple benefit/discount levels based on the number of shares owned, which can be presented to the users. Offerors may be limited to only participating companies for which users own stock. For example a company may reward owners of its stock by offering them a discount on certain products or services depending on the amount of stock owned. Alternatively, the pool of offerors may be expanded to include other participating companies, such as affiliates of user-owned companies, or third parties that are unaffiliated with the company whose stock is the basis for the offer. For example, a competitor might make offers to owners of a certain stock to try to entice them to change investments and/or try out new products. In such cases the stock that serves as the basis for whether a user can view an offer may or may not be the same stock that serves as the basis for whether the user qualifies for the offer. Company A may offer to make viewable an offer for discount to Company A products if a user owns its competitor's (company B's) stock, but can make the user's eligibility for the offer dependent on either Company A's stock, Company B's Stock and/or another companies stock. For example, a software maker may make an offer to any user who owns stock in certain computer hardware companies. Thresholds may be set by number of shares, size of the investment in USD, or any other suitable metric. The benefit conferred by the offer need not be a discount on a product or service. For example, the benefit could be access to a VIP membership or VIP lounge, podcasts, talks, concert tickets that can be redeemed, or a more traditional coupon. Offers may also include the opportunity to purchase stock directly from a company rather than through a brokerage, such as a “direct stock purchase plan.” Such offers may include qualifying terms such as that the user has to be an accredited investor, or be willing to make a stock purchase of a certain amount or volume. Such systems may be used as a method of funding startups, joint ventures or other types of entities. In further embodiments, an offer could be a digital asset such as a non-fungible token (NFT) or a cryptocurrency coin amount. Any suitable benefit known in the art or to be developed can be part of such an offer.

FIG. 4 illustrates a method of publishing an offer to a user 4. Publishing an offer to a user 4 may include determining offer visibility 41 and displaying the offer 42 with or without indicators. Determining offer visibility 41 involves confirming that a user is eligible to see an offer based on the stocks that they own in their portfolio, as kept in the user ownership data set, and any thresholds or other qualifying terms that an offeror has put on an offer in order for it to be visible to the user. It is worth noting that any of the qualifying terms or conditions discussed above that an offeror can set for a user to be eligible for an offer can also be set for a user to qualify to have the offer visible. The offer can then be displayed to the user with or without indicators. For example, an offer for which a user is qualified to accept or redeem may be displayed in bright colors or with a “REDEEM NOW” button or “ELIGIBLE” notification, or the like. Any suitable way of indicating to a user that they are immediately eligible to redeem or accept the offer may be used. Likewise an offer that is visible but for which a user does not qualify may be displayed in muted colors or greyed out. This may be combined with a bright red (or other suitable color) highlighting why the user does not qualify, such as “Own 5/of 50 shares required to qualify.” A user may be allowed to click on the offer in order to see additional eligibility requirements, such as requirements that must be met at the time of acceptance or redemption. In some implementations or with certain offers, the requirements for visibility and for acceptance/redemption may be the same such that a user can exercise any offer that they view. In other implementations, or with tiered offers for example, a user may see some offers that they qualify for and others for which they do not qualify. For example, the owner of 10 shares of Company A may see a tiered offer with indicators showing eligibility for owners of 1, 5 or 10 shares of Company A stock, and indicators showing non-eligibility for offers to owners of 50 or 100 shares of Company A stock.

FIG. 5 illustrates a method for conveying the benefit of an offer to a user 5. Conveying the benefit of an offer to a user 5 may include receiving a request to accept/redeem an offer 51, verifying the user's eligibility 52; and providing the offer benefit 53. When a user is ready to accept or redeem an offer they may communicate a request to the system which then receives the request to accept/redeem an offer 51. The user may do so by using an application, such as the one described below, or may do so at a point of sale by the offeror, which may be brick and mortar or online. When the offer is redeemed on the application, the system may verify the user's eligibility 52 by verifying that the user has met all requirements to qualify for the offer, including any qualifying terms and thresholds that must be met. If the request is made at the offeror's point of sale the request may be transmitted to the system by the offeror for verification, or alternatively, the offeror's point of sale may verify the user's eligibility by scanning or otherwise obtaining an identifier from the user, such as a QR code, which can be used to verify the user's eligibility. In some embodiments the identifier may be processed locally by the offeror's point of sale, provided that they have previously been provided with the user's ownership information in accordance with the user's authorizations as described above. Alternatively, the offeror's point of sale may make a request for information or for verification of the system by identifying the user via the provided identifier or any other suitable identifier. The system may then handle the verification or provide the offeror's point of sale with the information that is required for the point of sale to verify the user's eligibility for the offer being accepted/redeemed. Alternatively the identifier provided to the point of sale may be a self-executing verification, such as a coupon, containing the required data embedded in the identifier to identify the user and their eligibility to accept or redeem the offer. Once the user's eligibility is verified, the point of sale can then apply the offer benefit 53 by providing the user a discount on a purchase of goods or services, access to a VIP area, or any other benefit that falls within the scope of the offer. For example, where the benefit is to allow the user to invest through a direct stock purchase plan, the user application may be implemented to facilitate the execution of the required agreements and transactions, or the user may be directed to a website that has been established to facilitate same. In certain embodiments the operator of a system or platform that is facilitating the communication of the offer may receive a commission or percentage of any sale that is made as part of the redemption or acceptance of an offer in accordance with the disclosed concepts. Alternatively the operator of such a system or platform may be paid a flat fee for accepting and presenting offers, or per transaction of an offer being redeemed or accepted.

The operator of such a platform or system may also monetize and sell the data collected, in accordance with user authorizations. They may sell data or license access to data in aggregate anonymized form, or where authorized, may sell or license access to user-specific data. Such data may be mined to find users that meet certain criteria to be presented with offers through the system our outside of the system.

A non-transitory computer readable medium may be provided with instructions that when executed by a processor cause a computing system to implement any one or more of the methods described above.

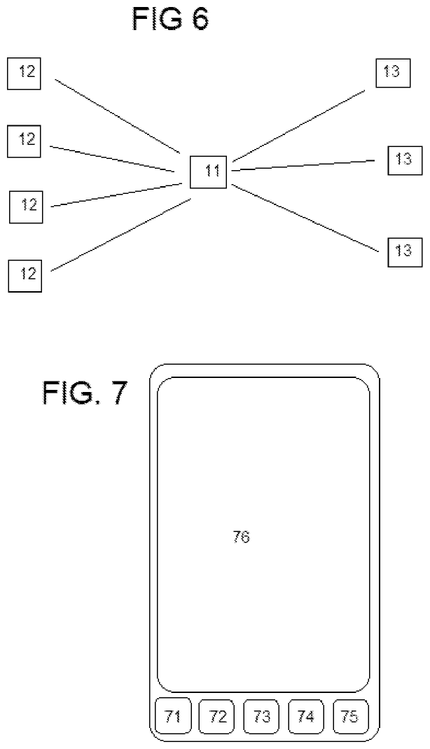

FIG. 6 illustrates a system for presenting offers to the shareholders of a company 10. Such a system 10 may include a computing device 11 having a memory and a processor. The computing device 11 may be a single, centralized computing device or may be a multiple device, distributed or decentralized computing system, or may have any other suitable architecture known in the art or to be developed. The computing device 11 may be capable of communicating with user devices 12 to receive information from a user to collect a user ownership data set in accordance with any of the methods described above. The computing device may further be capable of communicating with offeror computing devices 13 to receive offer information from an offeror to collect an offer data set in accordance with any of the methods described above, or may otherwise be capable of receiving such offer information (for example by direct data entry by system administrators, or by importing spreadsheets, csv, j son, or other file types containing such offer information, or any other suitable known or to be developed manner of receiving such offer data. The computing device 11 may further be capable of communicating with a user computing device to instruct that device to publish an offer to the user that the user is eligible to view in accordance with any of the methods described above. The computing device may also communicate with user devices 12 and/or offeror devices 13, such as those having offeror point-of-sale systems to facilitate acceptance or redemption and conveying of the offer benefit to a user in accordance with any of the methods described above.

FIG. 7 illustrates an exemplary user application graphical user interface 7 for an application that runs on a user's computing device 12, that may be implemented in accordance with the disclosed concepts. The user interface may be provided with control buttons, including a watchlist button 71, a discover button 72, an identifier button 73, a messaging button 74, and an account button 75, as well as a display area 76. The watchlist button 71 may provide the user with potential offers that they are eligible to view, and may further use the display area to accept input and allow the user to get additional details about such offers and/or accept or redeem such offers in accordance with the disclosure above. The discover button 72 may allow the user to filter and browse offers that are not dependent on his portfolio. The identifier button 73 may allow the user to present an identifier, such as a QR code, to redeem or accept an offer, as described above, or to connect with other users of the system as a social networking application. The identifier button 73 may also present the user with the option to scan an identifier of another user to connect with them as a social networking application. The messaging button 75 may allow the user to receive and send messages both with other users, and from the companies for which they own stock or from offerors that have made offers that the user has agreed to view or allow to message them. The account button 75 may allow the user to manage their account with the system including updating any demographic or other user data, link brokerage accounts, manage social connections through the application, and any other suitable use known in the art or to be developed. The display area 76 displays the information required depending on what buttons and control options have been selected.

It should be appreciated that embodiments of the system could reduce or eliminate the need for stock exchanges, brokers, clearing houses, and/or custodians by directly linking users of the system with companies the users wish to invest. For example, a user of the system could disclose the user's stock holdings directly with the company.

The descriptions set forth above are meant to be illustrative and not limiting. Various modifications to the disclosed embodiments, in addition to those described herein, will be apparent to those skilled in the art from the foregoing description. Such modifications are also intended to fall within the scope of the concepts described herein. The disclosures of each patent, patent application, and publication cited or described in this document are hereby incorporated herein by reference, in their entireties.

The foregoing description of possible implementations consistent with the present disclosure does not represent a comprehensive list of all such implementations or all variations of the implementations described. The description of some implementations should not be construed as an intent to exclude other implementations described. For example, artisans will understand how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention being indicated by the following claims.

We claim:

1. A method comprising:
collecting a user ownership data set including a number of shares of stock that a user owns in a first company;
collecting an offer data set including a first offer for shareholders who own a first threshold number of shares in the first company;
publishing the first offer to the user that owns the number of shares of stock of the first company.

2. The method of claim 1 wherein collecting the user ownership data set comprises collecting demographic information about the user including the user's name, birthdate, social security number, mailing address, phone number, or email address.

3. The method of claim 1 wherein the collecting the user ownership data set comprises a purchase date establishing when the number of shares of the stock of the first company were purchased by the user.

4. The method of claim 1 wherein the collecting a user ownership data set comprises transactional data showing the user's historical purchase and sale of shares of stock of the first company.

5. The method of claim 4 wherein the collecting the user ownership data set comprises aggregating the transactional data into a history of ownership of the stock of the first company by the user.

6. The method of claim 1 wherein the collecting a user ownership data set includes linking to the user's account on a third-party brokerage in order to collect verified data for the ownership data set.

7. The method of claim 1 wherein the collecting an offer data set further comprises a second offer for shareholders who own a second threshold number of shares in the first company.

8. The method of claim 7 wherein the first threshold number of shares and the second threshold number of shares are the same.

9. The method of claim 1 wherein the first offer is tiered having additional threshold number of shares and tiered benefits depending on which of the threshold number of shares is met.

10. The method of claim 1 wherein the first offer is from the first company or an affiliate of the first company.

11. The method of claim 1 wherein the first offer is from a company that is unaffiliated with the first company.

12. The method of claim 1 wherein the first offer includes qualifying terms.

13. The method of claim 12 wherein the qualifying terms require ownership of the first threshold number of shares of the first company for a first time period.

14. The method of claim 12 where the first offer requires ownership of the threshold number of shares at the time the first offer is accepted or redeemed.

15. The method of claim 1 wherein the first offer comprises a discount on a good or service.

16. The method of claim 1 wherein the publishing the first offer to the user that owns the number of shares of stock of the first company comprises verifying that the user qualifies for the first offer and indicating that the first offer is available to the user for acceptance or redemption.

17. The method of claim 1 wherein the publishing the first offer to the user that owns the number of shares of stock of the first company comprises verifying that the user does not qualify for the first offer and indicating the requirements that the user must meet in order to qualify for the first offer.

18. The method of claim 1 further comprising receiving a request from the user to accept or redeem the first offer.

19. A non-transitory computer readable medium containing instructions that when executed by a processor cause a computing system to:
collect a user ownership data set including a number of shares of stock that a user owns in a first company;
collect an offer data set including a first offer for shareholders who own a first threshold number of shares in the first company;
publish the first offer to the user that owns the number of shares of stock of the first company.

20. A system comprising:
a computing device comprising a memory and a processor;
the computing device capable of receiving information from a user to collect a user ownership data set including a number of shares of stock that the user owns in a first company;
the computing device capable of receiving offer information from an offeror to collect an offer data set including a first offer for shareholders who own a first threshold number of shares in the first company;
the computing device further capable of communicating with a user computing devise operated by the user to publish the first offer to the user that owns the number of shares of stock of the first company.
